(19) United States
(12) Patent Application Publication
(10) Pub. No.: US 2010/0077341 A1
(43) Pub. Date: Mar. 25, 2010

(54) SMART CONTENT PRESENTATION

(75) Inventor: Chien-Hung Zordius Chen, Taipei (TW)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/235,337

(22) Filed: Sep. 22, 2008

(51) Int. Cl. G06F 3/048

(52) U.S. Cl. 715/782; 715/781

(57) ABSTRACT

A method and apparatus is described herein that modifies the manner in which content is presented to a display screen of an electronic device based on sensed motion of the electronic device. Such method and apparatus advantageously allows content to be automatically presented to the display screen in a manner that is responsive to a current orientation, position, or motion of electronic device. This functionality can advantageously be used to enhance the appearance and/or utility of content presented to a user. A method and apparatus is also described herein that automatically selects content, or a portion of content, for presentation to the display screen of an electronic device based on sensed motion of the electronic device. Such method and apparatus advantageously allows a user to control what content is delivered to the display screen by simply moving the electronic device.

### BACKGROUND OF THE INVENTION

1. Field of the Invention

The present invention generally relates to the manner in which content is presented to display screens of electronic devices, including but not limited to portable electronic devices.

2. Background

A wide variety of electronic devices available today include display screens for presenting content to a user. Such devices include but are not limited to portable electronic devices such as cellular telephones, personal digital assistants (PDAs), media players, laptop computers, tablet computers, or the like. The content presented to the user via the display screen may include, for example, images, text, video or the like.

A user of such a portable electronic device may change the orientation of the device during use such that content presented via the display screen is not optimally aligned for viewing by the user. In such instances, the user must re-orient the device in order to properly view the content.

An image presented to the display screen of such a portable electronic device may also be presented in a manner that is not of optimal utility to the user. For example, a map comprising an image and associated text may be presented to the user in an orientation that is not of optimal utility to the user. If the portable electronic device is a handheld device, then the user may physically rotate the device to obtain the desired orientation for the image. However, by so doing, the user may render the associated text un-readable.

Some applications are programmed to allow a user to change the orientation of images or other content presented to a display screen, or to actively select content or a portion thereof for presentation to the display screen. However, such applications typically require the user to manipulate an input device associated with the portable electronic device, such as a keyboard, keypad, touch screen, or the like, in order to make such changes or selections. Depending on the context of the user, manipulating the input device in this manner may be inconvenient or even impossible.

What is needed, then, is system and method for presenting content to the display screen of an electronic device, such as a portable electronic device, that addresses one or more of the shortcomings associated with conventional electronic devices.

### BRIEF SUMMARY OF THE INVENTION

A method and apparatus is described herein that modifies the manner in which content is presented to a display screen of an electronic device based on sensed motion of the electronic device. Such method and apparatus advantageously allows content to be automatically presented to the display screen in a manner that is responsive to a current orientation, position, or motion of electronic device. This functionality can advantageously be used to enhance the appearance and/or utility of content presented to a user. A method and apparatus is also described herein that automatically selects content, or a portion of content, for presentation to the display screen of an electronic device based on sensed motion of the electronic device. Such method and apparatus advantageously allows a user to control what content is delivered to the display screen by simply moving the electronic device.

In particular, a method for presenting content to a display screen of an electronic device is described herein. In accordance with the method, motion of the electronic device is sensed. Sensor data is generated responsive to the sensed motion. An orientation of at least a portion of the content to be presented to the display screen is then modified based on the sensor data. The content is then presented to the display screen. In accordance with the foregoing method, the content may comprise one or more of text, an image, or a video. In one embodiment, the content comprises an image and text, and modifying the orientation of at least a portion of the content to be presented to the display screen comprises rotating the image but not rotating the text.

An alternate method for presenting content to a display screen of an electronic device is also described herein. In accordance with the method, motion of the electronic device is sensed. Sensor data is then generated responsive to the sensed motion. A portion of the content is then selected for presentation to the display screen based on the sensor data. The selection portion of the content is then presented to the display screen. In accordance with the foregoing method, the content may comprise one or more of text, an image, or a video. In one embodiment, selecting the portion of the content for presentation to the display screen based on the sensed motion includes determining that the sensor data is associated with a scrolling function and selecting the portion of the content based on scrolling the content upward or downward within the display screen responsive to determining that the sensor data is associated with the scrolling function.

A method for presenting a view of a three-dimensional (3D) object to a display screen of an electronic device is also described herein. In accordance with the method, motion of the electronic device is sensed. Sensor data is generated responsive to the sensed motion. One of a plurality of views of the 3D object is then selected based on the sensor data. The selected view of the 3D object is then presented to the display screen.

An electronic device is also described herein. The electronic device includes a display screen, motion detection logic, a content source, content presentation logic and a display interface. The motion detection logic is configured to sense motion of the electronic device and to generate sensor data responsive to the sensed motion. The content source is configured to provide content for presentation to the display screen. The content presentation logic is configured to modify an orientation of at least a portion of the content to be presented to the display screen based on the sensor data. The display interface is configured to present the content to the display screen.

Depending upon the implementation of the electronic device, the motion detection logic may include one or more of an accelerometer, a compass sensor, or an orientation sensor. The content may include one or more of text, an image, or a video. In one embodiment, the content comprises an image and text, and the content presentation logic is configured to rotate the image but not rotate the text.

Another electronic device is also described herein. This electronic device includes a display screen, motion detection logic, a content source, content presentation logic and a display interface. The motion detection logic is configured to sense motion of the electronic device and to generate sensor data responsive to the sensed motion. The content source is configured to provide content for presentation to the display screen. The content presentation logic is configured to select a portion of the content for presentation to the display screen based on the sensor data. The display interface is configured to present the selected portion of the content to the display screen.

Depending upon the implementation of the electronic device, the motion detection logic may include one or more of an accelerometer, a compass sensor, or an orientation sensor. The content may include one or more of text, an image, or a video.

In one embodiment, the content presentation logic is configured to determine that the sensor data is associated with a scrolling function and to select the portion of the content based on scrolling the content upward or downward within the display screen responsive to determining that the sensor data is associated with the scrolling function.

Yet another electronic device is described herein. This electronic device includes a display screen, motion detection logic, a content source, content presentation logic and a display interface. The motion detection logic is configured to sense motion of the electronic device and to generate sensor data responsive to the sensed motion. The content source is configured to provide multiple views of a three-dimensional (3D) object. The content presentation logic is configured to select one of the multiple views of the 3D object based on the sensor data. The display interface is configured to present the selected view of the 3D object to the display screen.

Depending upon the implementation of the electronic device, the motion detection logic may include one or more of an accelerometer, a compass sensor, or an orientation sensor.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example electronic device that implements the present invention.

FIG. 2 depicts an example acceleration sensor that may be used to detect the acceleration of an electronic device in accordance with an embodiment of the present invention.

FIG. 3 depicts an example compass sensor that may be used to determine the heading of an electronic device in accordance with an embodiment of the present invention.

FIG. 4 depicts an example orientation sensor that may be used to determine an orientation of a display screen of an electronic device in accordance with an embodiment of the present invention.

FIG. 5 illustrates a plurality of orientations of a display screen of an electronic device that may be determined by an orientation sensor in accordance with an embodiment of the present invention.

FIG. 6 depicts a flowchart of an example method for presenting content to a display screen of an electronic device in accordance with an embodiment of the present invention.

FIGS. 7 and 8 collectively illustrate an example application of the method of the flowchart of FIG. 6 that may be used to enhance the viewing of content presented to a display screen of an electronic device.

FIG. 9 and 10 illustrate an example application of the method of the flowchart of FIG. 6 in which an image to be presented to the display screen of an electronic device is rotated while text elements to be presented to the display screen are not.

FIG. 11 depicts a flowchart of an alternative method for presenting content to a display screen of an electronic device in accordance with an embodiment of the present invention.

FIGS. 12, 13 and 14 collectively illustrate an example application of the method of the flowchart of FIG. 1 in which an image is scrolled downward within a display screen of an electronic device responsive to motion of the device.

FIG. 15 depicts a flowchart of a method for presenting a view of a three-dimensional (3D) object to a display screen of an electronic device in accordance with an embodiment of the present invention.

FIGS. 16, 17 and 18 collectively illustrate an example application of the method of the flowchart of FIG. 15 in which different views of a 3D object are selectively presented within a display screen of an electronic device responsive to the orientation of the device.

FIGS. 19 and 20 collectively illustrate an example application of the method of the flowchart of FIG. 15 in which different views of a 3D object are selectively presented within a display screen of an electronic device responsive to motion of the device.

FIG. 21 is a block diagram of a computer system that may be used to implement one or more aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

B. Example Electronic Device in Accordance with an Embodiment of the Present Invention

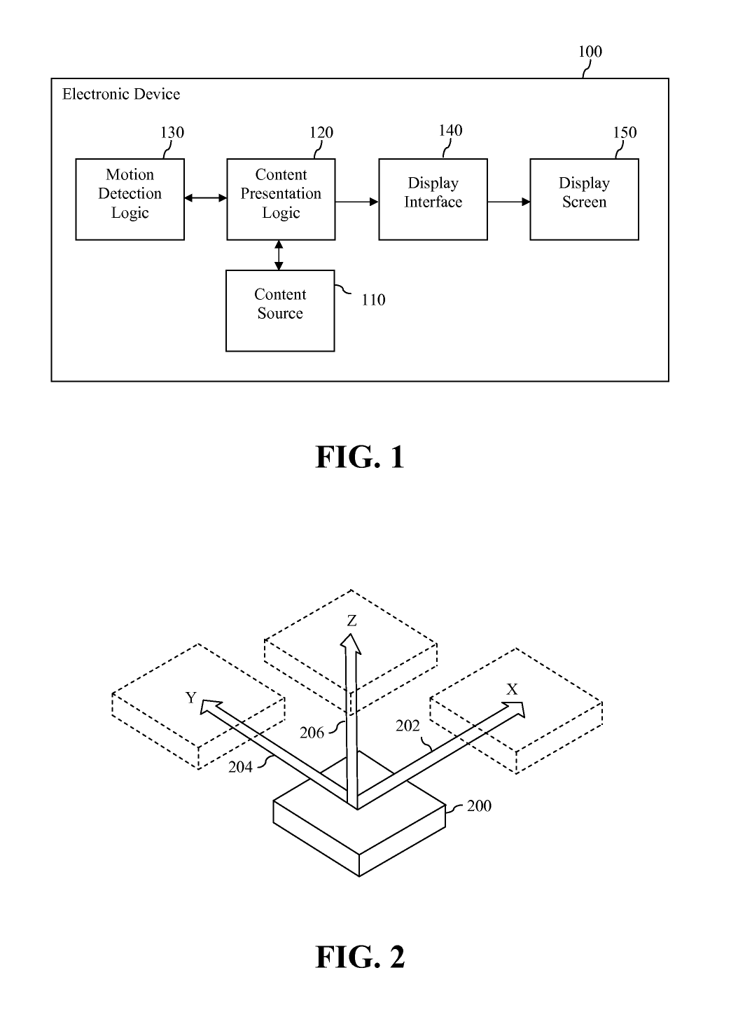

FIG. 1 is a functional block diagram of an example electronic device 100 that implements the present invention. Electronic device 100 may represent, for example, a portable electronic device, such as a cellular telephone, personal digital assistant (PDA), media player, laptop computer, or tablet computer, although these examples are not intended to be limiting. As shown in FIG. 1, example electronic device 100 includes a number of interconnected components including a content source 110, content presentation logic 120, motion detection logic 130, a display interface 140 and a display screen 150. Each of these elements will now be described.

Content source 110 comprises logic that is configured to provide content, such as images, text, video or the like, for display to a user via display screen 150 of electronic device 100. Depending upon the implementation, content source 110 may obtain such content locally (e.g., by dynamically generating the content or by obtaining the content from a memory that is internal to electronic device 100) or from a remote entity or device via a wired or wireless connection. In an embodiment, content source 110 includes software or firmware executing on one or more processors or processor cores internal to electronic device 100. Content source 110 may include, for example, a graphical user interface (GUI), Web browser, media player, image viewer, map viewer, presentation program, word processor, or other application or process capable of providing content for display to a user via display screen 150.

Content presentation logic 120 comprises logic that is configured to receive content provided by content source 110 and to determine the manner in which such content will be presented to display screen 150 based on data received from motion detection logic 130. Content presentation logic 120 may also be configured to selectively determine what content or what portion of content should be provided by content source 110 for presentation to display screen 150 based on data received from motion detection logic 130. The manner in which content presentation logic 120 operates will be described in more detail herein. In one embodiment, content presentation logic 120 is implemented in software or firmware executing on one or more processors or processor cores internal to electronic device 100.

In one embodiment, content source 110 and content presentation logic 120 each form part of the same application or process. In such an embodiment, the application or process may be thought of as having the “built-in” capabilities of content presentation logic 120. In another embodiment, content presentation logic 120 executes independently with respect to content source 110 but is configured to intercept communications between content source 110 and display interface 140 in order to perform its assigned functions.

Motion detection logic 130 comprises logic that is configured to sense when electronic device 100 has been moved and to provide data relating to the movement of the device to content presentation logic 120. To perform these functions, motion detection logic 130 may include one or more motion detection sensors. Various types of motion detection sensors are known in the art. Depending upon the type of motion detection sensor used, different types of motion of electronic device 100 may be sensed.

For example, motion detection logic 130 may include a sensor that is configured to detect acceleration of electronic device 100 in one or more directions. Such a sensor may be referred to as an accelerometer. Certain accelerometers are capable of measuring acceleration along each of three orthogonal axes. By way of illustration, FIG. 2 depicts an example accelerometer 200 that may be used to measure acceleration of electronic device 100 along each of three orthogonal axes, denoted X-axis 202, Y-axis 204, and Z-axis 206, respectively. By using the measurements provided by accelerometer 200, acceleration of electronic device 100 in any direction can be sensed and quantified. Such acceleration may be caused, for example, by lifting, vibrating, rotating, tilting, or dropping electronic device 100. One example of an accelerometer that can provide an acceleration measurement along each of three orthogonal axes is the LIS302DL accelerometer, which is an integrated circuit manufactured and sold by STMicroelectronics of Geneva Switzerland. However, this is only one example, and various other types of accelerometers may be used.

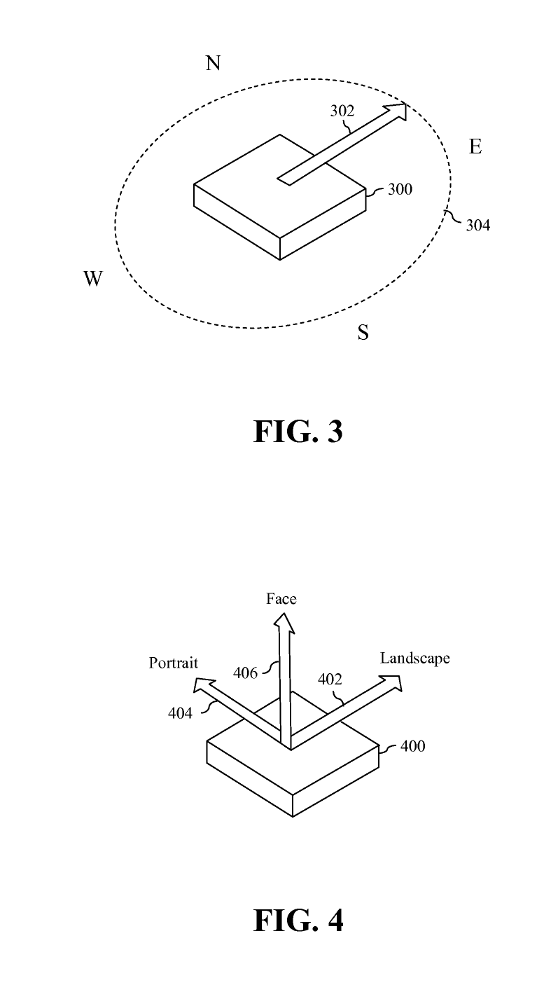

As another example, motion detection logic 130 may include a compass sensor that is configured to determine a heading of electronic device 100 with respect to the magnetic field of the earth. As will be appreciated by persons skilled in the relevant art(s), compass sensors utilize magnetometers that are capable of detecting the weak magnetic field of the earth to determine such a heading. By way of illustration, FIG. 3 depicts an example compass sensor 300 that can be used to determine a heading 302 of electronic device 100 with respect to the magnetic field of the earth, which is indicated by reference numeral 304. Heading 302 may be indicated, for example, as a number of degrees from magnetic north. Heading 302 of compass sensor 300 may be changed, for example, by rotating or changing the position of electronic device 100. One example of a compass sensor is the HMC6352 integrated circuit manufactured and sold by Honeywell International Inc. of Morristown, N.J. However, this is only one example, and various other types of compass sensors may be used.

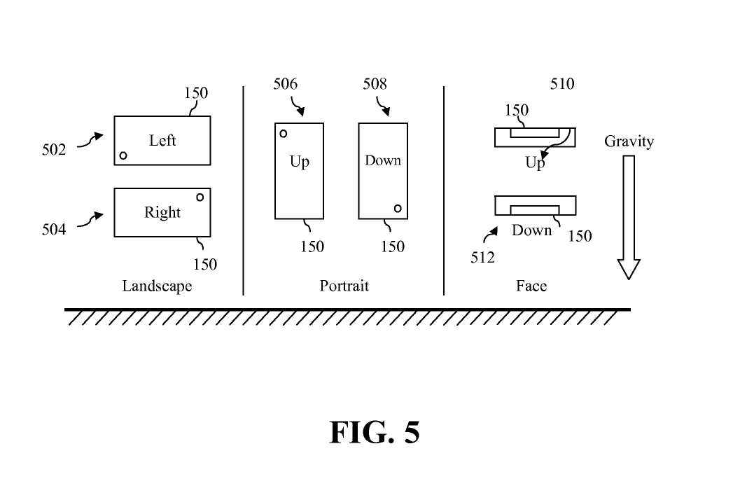

As a further example, motion detection logic 130 may include an orientation sensor that is configured to detect an orientation of display screen 150 of electronic device 100 relative to gravity based on predefined orientation definitions. By way of illustration, FIG. 4 depicts an example 3D orientation sensor 400 that can be used to determine an orientation of display screen 150 in three orthogonal directions, denoted landscape 402, portrait 404, and face 406. In one embodiment, orientation sensor 400 can sense six possible orientations of display screen 150 with respect to gravity based on these directions. These orientations are depicted in FIG. 5. As shown in that figure, the orientations include landscape left 502, landscape right 504, portrait left 506, portrait right 508, face up 510 and face down 512. One example of an orientation sensor that provides such functionality is the FC30 MEMS functional sensor, which is an integrated circuit manufactured and sold by STMicroelectronics of Geneva Switzerland. However, this is only one example, and various other types of orientation sensors may be used.

Display interface 140 comprises hardware that is configured to receive content from content presentation logic 120 and to convert such content into a form that is viewable on display screen 150. Display interface 140 may also include a software component, such as a device driver, that facilitates communication between the hardware of display interface 140 and various software elements.

### C. Smart Content Presentation

In one embodiment of the present invention, content presentation logic 120 is configured to receive content provided by content source 110 and selectively modify the manner in which such content is presented to display screen 150 based on data received from motion detection logic 110, thereby enabling the content to be presented to the user in a manner that is responsive to a current orientation, position, or motion of electronic device 100. As will be explained in more detail below, such functionality can advantageously be used to enhance the appearance and/or utility of content presented to the user.

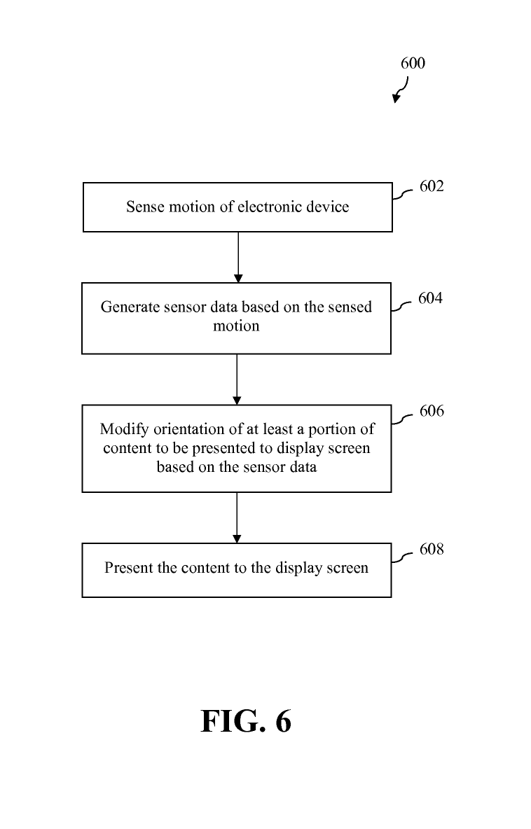

To provide a further understanding of this functionality, FIG. 6 depicts a flowchart 600 of an example method for presenting content to a display screen of an electronic device in accordance with an embodiment of the present invention. The method of flowchart 600 will now be described with continued reference to electronic device 100 as described above in reference to FIG. 1. However, the invention is not limited to that implementation.

As shown in FIG. 6, the method of flowchart 600 begins at step 602 in which motion detection logic 130 senses motion of electronic device 100. Depending upon the implementation, the motion sensed by motion detection logic 130 may include one or more of a motion that results in acceleration (or a change of acceleration) of electronic device 100 in a certain direction or directions as sensed by an acceleration sensor, a motion that results in a change of a heading of electronic device 100 with respect to the magnetic field of the earth as sensed by a compass sensor, or a motion that results in a change of orientation of display screen 150 as sensed by an orientation sensor. However, these examples are not intended to be limiting, and other types of motion may be detected by motion detection logic 130.

At step 604, motion detection logic 130 generates sensor data based on the sensed motion. Such sensor data is provided from motion detection logic 130 to content presentation logic 120.

At step 606, content presentation logic 120 receives content from content source 110 for presentation to display screen 150 and modifies an orientation of at least a portion of the content based on the sensor data received from motion detection logic 130. The content received from content source 110 may comprise, for example, an image, text, video, or any combination thereof. Modifying the orientation of at least the portion of the content may include, for example, rotating or otherwise changing the orientation of at least a portion of the content.

At step 608, content presentation logic 120 provides the content, including the portion(s) having a modified orientation, to display interface 140. Display interface 140 converts such content into a form that is viewable on display screen 150.

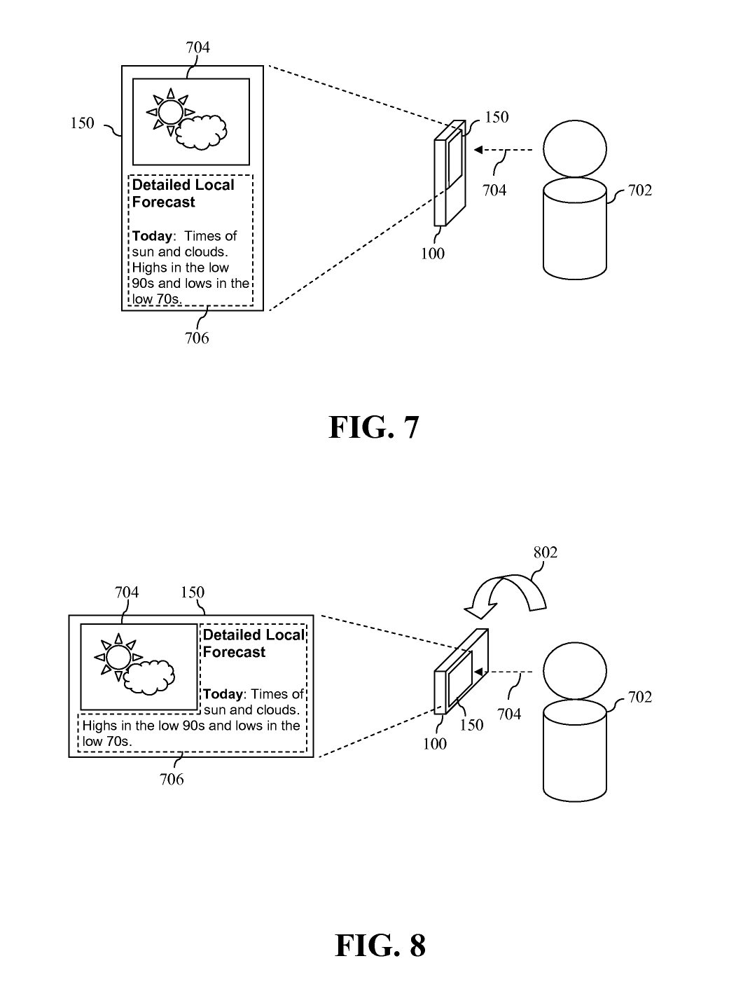

FIGS. 7 and 8 depict an example application of the method of flowchart 600 that may advantageously be used to enhance the viewing of content presented to display screen 150 of electronic device 100. As shown in FIG. 7, a user 702 of electronic device 100 is viewing content on display screen 150, wherein the content includes an image 704 and text 706. User 702 is holding electronic device 100 such that display screen 150 is in a first orientation relative to a perspective 704 of user 702. This first orientation may be thought of as a portrait orientation. In FIG. 7, content presentation logic 120 has caused image 704 and text 706 to be presented to display screen 150 in a manner that is aligned with the first orientation.

In FIG. 8, a rotation 802 of electronic device 100 has caused display screen 150 to be in a second orientation relative to perspective 704 of user 702. This second orientation may be thought of as a landscape orientation. In accordance with an embodiment of the present invention, rotation 802 of electronic device 100 is sensed by motion detection logic 130 within electronic device 100. For example, motion detection logic 130 may include an acceleration sensor or orientation sensor that senses rotation 802 of electronic device 100. Responsive to sensing the rotation, motion detection logic 130 generates sensor data and provides the sensor data to content presentation logic 120.

As further shown in FIG. 8, responsive to receiving the sensor data, content presentation logic 120 automatically changes the orientation of both image 704 and text 706 such that image 704 and text 706 are now presented to display screen 150 in a manner that is aligned with the second orientation of display screen 150. By rotating image 704 and text 706 in this way, content presentation logic 120 enables user 704 to continue to view image 704 and read text 706 in a desired manner without having to change his/her perspective 704.

The foregoing is only one example of how content presentation logic 120 may rotate content to align with an orientation of display screen 150. For example, although FIGS. 7 and 8 depict the rotation of an image and text only, other types of content, such as video content, may also be rotated to improve viewing. Furthermore, content may be rotated to align with any number of orientations. For example, in one implementation, content may be rotated to align with any of the following orientations shown in FIG. 5: landscape left, landscape right, portrait up and portrait down. In further implementations, content may be rotated anywhere in a range from 0° to 360° in order to align with any number of orientations of display screen 150.

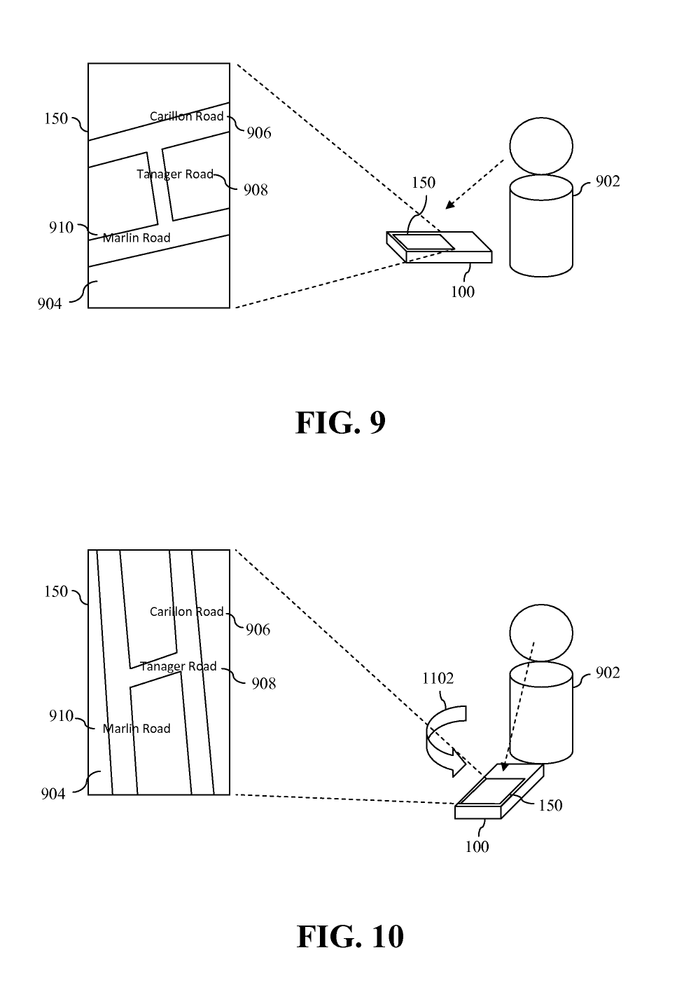

In some embodiments, content presentation logic 120 may rotate certain types of content while not rotating other types of content responsive to motion of user device 100. FIGS. 9 and 10 depict an example application of flowchart 600 in accordance with such an embodiment. As shown in FIG. 9, a user 902 of electronic device 100 is viewing content on display screen 100, wherein the content is a two-dimensional (2D) map comprising a map image 904 and map text elements 906, 908 and 910. User 902 is holding electronic device 100 such that display screen 150 is in a first viewing position.

As shown in FIG. 10, as user 902 has rotated counterclockwise, a corresponding motion 1102 of electronic device 100 has occurred that has caused display screen 150 to be in a second viewing position. In accordance with an embodiment of the present invention, motion 1102 of electronic device 100 is sensed by motion detection logic 130 within electronic device 100. For example, motion detection logic 130 may include an acceleration sensor or compass sensor that senses motion 1102 of electronic device 100. Responsive to sensing the motion, motion detection logic 130 generates sensor data and provides the sensor data to content presentation logic 120.

As further shown in FIG. 10, responsive to receiving the sensor data, content presentation logic 120 changes the orientation of map image 904. For example, content presentation logic 120 may rotate map image 904 in a direction that corresponds to the direction in which display screen 150 has been rotated about user 902. Content presentation logic 120 may also rotate map image 904 by a degree that roughly corresponds to the degree by which display screen 150 has been rotated about user 902. This advantageously enables user 904 to change his/her perspective of map image 904 through a simple movement of electronic device 100. However, content presentation logic 120 does not change the orientation of map text elements 904, 906 and 908 responsive to receiving the sensor data, which serves to ensure that user 902 can still read the important text elements associated with the map.

In a further embodiment of the present invention, content presentation logic 120 is configured to selectively determine what portion of content should be provided by content source 110 for presentation to display screen 150 based on data received from motion detection logic 130. As will be explained in more detail below, such functionality can advantageously be used to allow a user to select a portion of content for viewing based on a simple movement of electronic device 100.

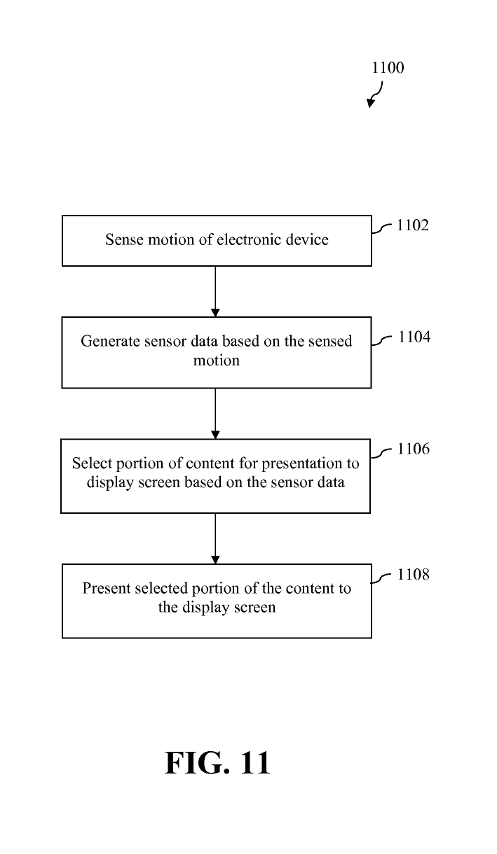

To provide a further understanding of this functionality, FIG. 11 depicts a flowchart 1100 of an alternative method for presenting content to a display screen of an electronic device in accordance with an embodiment of the present invention. The method of flowchart 1100 will now be described with continued reference to electronic device 100 as described above in reference to FIG. 1. However, the invention is not limited to that implementation.

As shown in FIG. 11, the method of flowchart 1100 begins at step 1102 in which motion detection logic 130 senses motion of electronic device 100. Depending upon the implementation, the motion sensed by motion detection logic 130 may include one or more of a motion that results in acceleration (or a change of acceleration) of electronic device 100 in a certain direction or directions as sensed by an acceleration sensor, a motion that results in a change of a heading of electronic device 100 with respect to the magnetic field of the earth as sensed by a compass sensor, or a motion that results in a change of orientation of display screen 150 as sensed by an orientation sensor. However, these examples are not intended to be limiting, and other types of motion may be detected by motion detection logic 130.

At step 1104, motion detection logic 130 generates sensor data based on the sensed motion. Such sensor data is provided from motion detection logic 130 to content presentation logic 120.

At step 1106, content presentation logic 120 selects a portion of content provided by content source 110 for presentation to display screen 150 based on the sensor data received from motion detection logic 130. The content received from content source 110 may comprise, for example, an image, text, video, or any combination thereof. Selecting the portion of the content may include, for example, selecting a portion of an image, text, or a video based on the sensor data received from motion detection logic 130.

At step 1108, content presentation logic 120 provides the selected content to display interface 140. Display interface 140 converts such content into a form that is viewable on display screen 150.

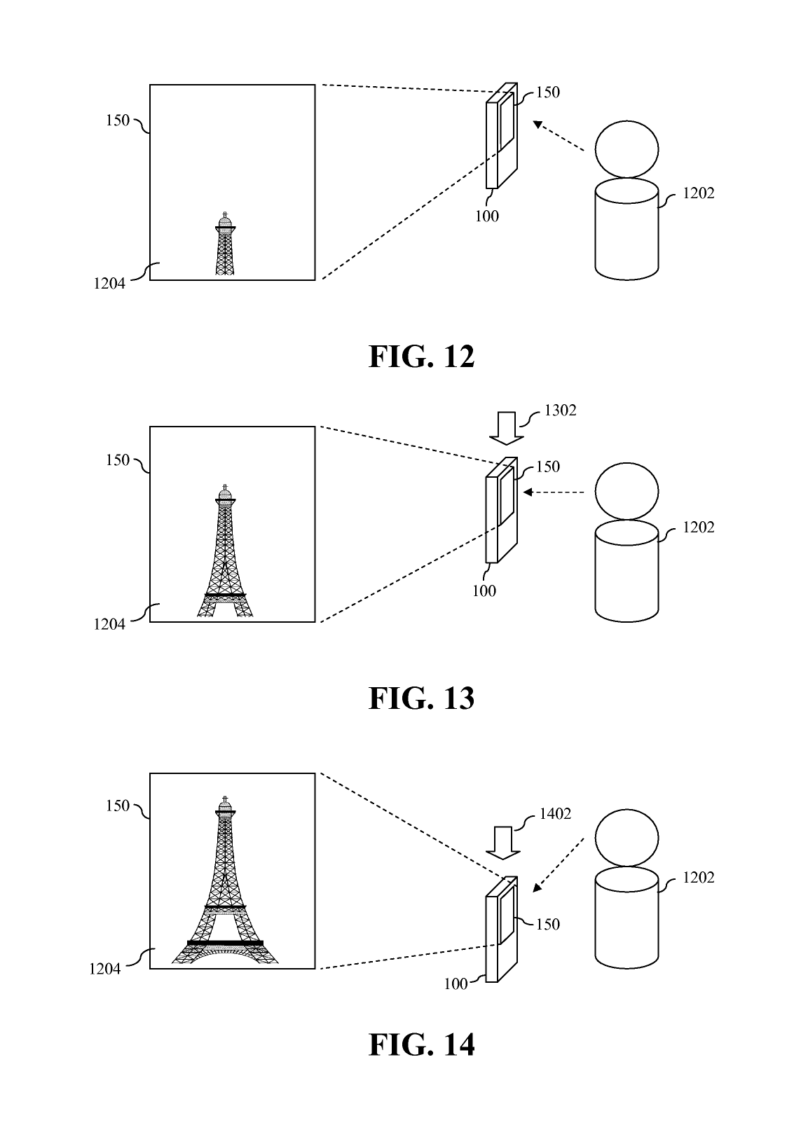

One example application of the method of flowchart 1100 will now be described with respect to FIGS. 12-14. As shown in FIG. 12, a user 1202 is viewing content on display screen 150, wherein the content is provided by content source 110 and comprises an image 1204 that is too long to fit within the upper and lower display screen boundaries. As a result only a first portion of image 1204 is visible to the user. User 1202 is holding electronic device in a first position.

As shown in FIG. 13, user 1202 has moved electronic device 100 downward to a second position. In accordance with an embodiment of the present invention, the downward motion of electronic device 100, denoted motion 1302 in FIG. 13, is sensed by motion detection logic 130 within electronic device 100. For example, motion detection logic 130 may include an acceleration sensor that senses downward motion 1302 of electronic device 100. Responsive to sensing the rotation, motion detection logic 130 generates sensor data and provides the sensor data to content presentation logic 120.

As further shown in FIG. 13, responsive to receiving the sensor data from motion detection logic 130, content presentation logic 120 determines that the sensor data is associated with a “scroll down” function. Consequently, content presentation logic 120 scrolls image 1204 downward within display screen 150, thereby making a new portion of the image visible to user 1202. FIG. 14 shows that as further downward motion 1402 occurs, additional sensor data is generated by motion detection logic 130 that causes content presentation logic 120 to scroll image 1204 even further downward within display screen 150, thereby making yet another portion of the image visible to user 1202. This application thus enables a user to scroll content down within display screen 150 based on a simple movement of electronic device 100.

Although the foregoing example describes a scenario in which motion of electronic device 100 may be used to implement a “scroll down” function, persons skilled in the relevant art(s) will readily appreciate that the concept may be beneficially extended to cause content to be scrolled upward, left, right, or in any other direction within display screen 150 depending upon the direction of motion sensed. Such scrolling may be applied to any type of content including but not limited to images, text, video or any combination thereof.

In a still further embodiment of the present invention, content presentation logic 120 is configured to select a view of a three-dimensional (3D) object from among a plurality of views of the 3D object provided by content source 110 for presentation to display screen 150 based on data received from motion detection logic 130. As will be explained in more detail below, such functionality can advantageously be used to allow a user to view a simulated 3D object from one of a variety of perspectives simply by moving or changing the orientation of electronic device 100.

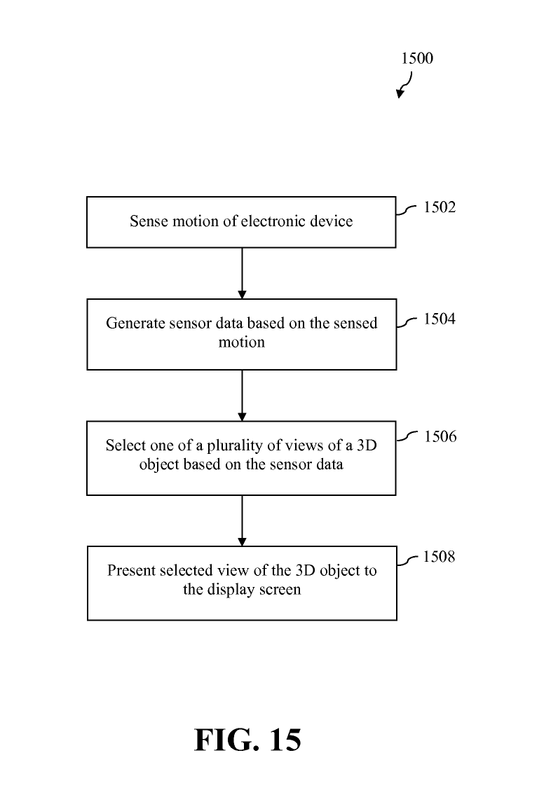

To provide a further understanding of this functionality, FIG. 15 depicts a flowchart 1500 of a method for presenting a view of a 3D object to a display screen of an electronic device in accordance with an embodiment of the present invention. The method of flowchart 1500 will now be described with continued reference to electronic device 100 as described above in reference to FIG. 1. However, the invention is not limited to that implementation.

As shown in FIG. 15, the method of flowchart 1500 begins at step 1502 in which motion detection logic 130 senses motion of electronic device 100. Depending upon the implementation, the motion sensed by motion detection logic 130 may include one or more of a motion that results in acceleration (or a change of acceleration) of electronic device 100 in a certain direction or directions as sensed by an acceleration sensor, a motion that results in a change of a heading of electronic device 100 with respect to the magnetic field of the earth as sensed by a compass sensor, or a motion that results in a change of orientation of display screen 150 as sensed by an orientation sensor. However, these examples are not intended to be limiting, and other types of motion may be detected by motion detection logic 130.

At step 1504, motion detection logic 130 generates sensor data based on the sensed motion. Such sensor data is provided from motion detection logic 130 to content presentation logic 120.

At step 1506, content presentation logic 120 selects one of a plurality of views of a 3D object that can be provided or generated by content source 110 for presentation to display screen 150 based on the sensor data received from motion detection logic 130. Each of the plurality of views of the 3D object may represent a different perspective of the 3D object.

At step 1508, content presentation logic 120 provides the selected view of the 3D object to display interface 140. Display interface 140 converts the selected view of the 3D object into a form that is viewable on display screen 150.

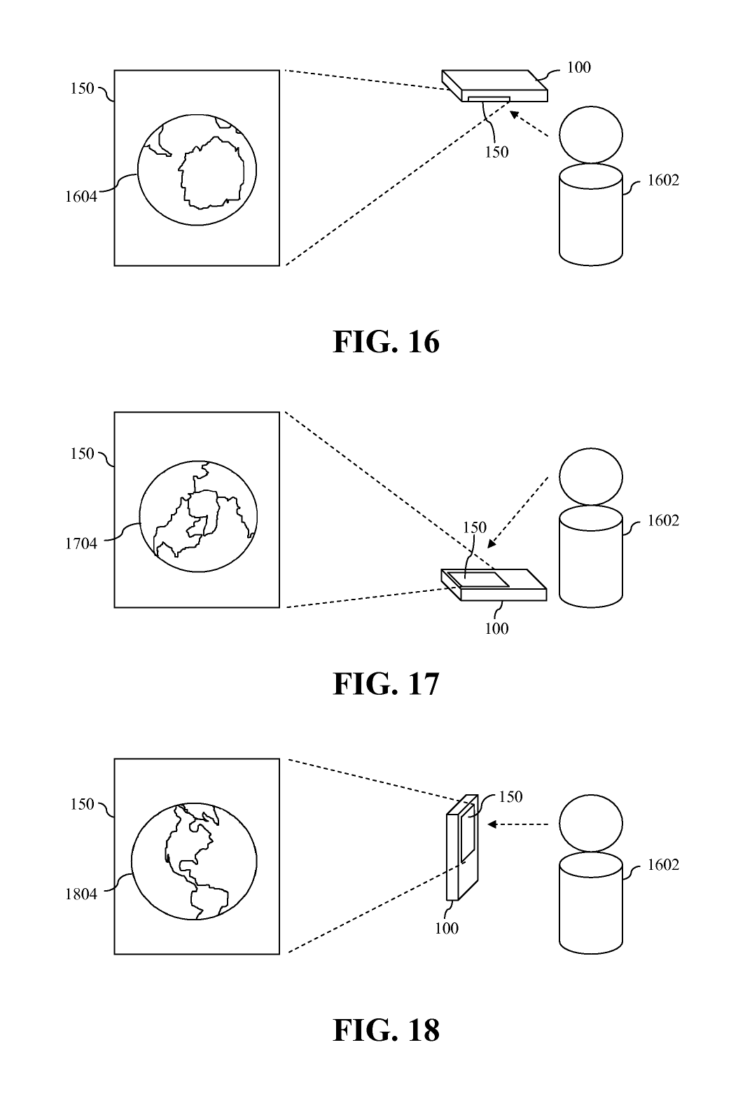

One example application of the method of flowchart 1500 will now be described with respect to FIGS. 16-18. In each of these figures, a user 1602 is shown viewing content on display screen 150, wherein the content comprises a view of a 3D object, and wherein the 3D object comprises a model of the earth. In accordance with the example application shown in FIGS. 16-18, the view of the 3D earth that is presented to user 1602 depends upon the current orientation of display screen 150 relative to gravity.

Thus, for example, in FIG. 16, user 1602 holds electronic device 100 such that display screen 150 is in a face down orientation with respect to gravity. Motion detection logic 130 identifies this orientation based on sensing the motion of electronic device 100 and generates corresponding sensor data for provision to content presentation logic 120. Motion detection logic 130 may include, for example, an acceleration sensor or an orientation sensor to perform this function. As further shown in FIG. 16, responsive to receiving the sensor data from motion detection logic 130, content presentation logic 120 selects a view 1604 of the 3D earth provided by content source 110 that corresponds to a bottom, or south pole, view of the 3D earth and presents it to the user via display screen 150.

As a further example, in FIG. 17, user 1602 holds electronic device 100 such that display screen 150 is in a face up orientation with respect to gravity. Motion detection logic 130 identifies this orientation based on sensing the motion of electronic device 100 and generates corresponding sensor data for provision to content presentation logic 120. As further shown in FIG. 17, responsive to receiving the sensor data from motion detection logic 130, content presentation logic 120 selects a view 1704 of the 3D earth provided by content source 110 that corresponds to a top, or north pole, view of the 3D earth and presents it to the user via display screen 150.

As yet another example, in FIG. 18, user 1602 holds electronic device 100 such that display screen 150 is in a side-facing orientation with respect to gravity. Motion detection logic 130 identifies this orientation based on sensing the motion of electronic device 100 and generates corresponding sensor data for provision to content presentation logic 120. As further shown in FIG. 18, responsive to receiving the sensor data from motion detection logic 130, content presentation logic 120 selects a view 1804 of the 3D earth provided by content source 110 that corresponds to a side, or equatorial, view of the 3D earth and presents it to the user via display screen 150.

Thus, using the application illustrated in FIGS. 16-18, a user can easily view a 3D object, such as a 3D earth, from various perspectives simply by changing the orientation of display screen 150 of electronic device 100. Although only three orientations are shown in FIGS. 16-18, respectively, persons skilled in the relevant art(s) will appreciate that any number of orientations may be detected and mapped to a corresponding view of a 3D object in accordance with embodiments of the present invention.

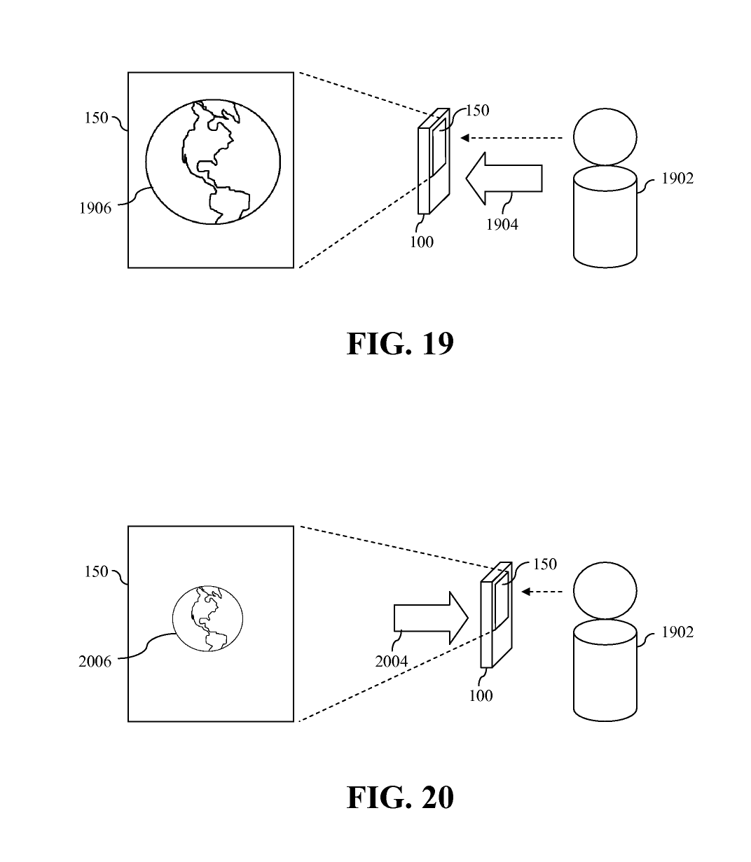

Another example application of the method of flowchart 1500 will now be described with respect to FIGS. 19 and 20. In each of these figures, a user 1902 is shown viewing content on display screen 150, wherein the content comprises a view of a 3D object, and wherein the 3D object again comprises a model of the earth. In accordance with the example application shown in FIGS. 19 and 20, the size of the view of the 3D earth that is presented to user 1902 depends upon sensed motion of electronic device 100.

Thus, for example, in FIG. 19, user 1902 has moved electronic device 100 away from him/her, thereby generating motion 1904. Motion detection logic 130 senses motion 1904 and generates corresponding sensor data for provision to content presentation logic 120. Motion detection logic 130 may include, for example, an acceleration sensor to perform this function. As further shown in FIG. 19, responsive to receiving the sensor data from motion detection logic 130, content presentation logic 120 selects an enlarged view 1906 of the 3D earth provided by content source 110 for presentation to the user via display screen 150.

As a further example, in FIG. 20, user 1902 has moved electronic device 100 towards him/her, thereby generating motion 2004. Motion detection logic 130 senses motion 2004 and generates corresponding sensor data for provision to content presentation logic 120. As further shown in FIG. 20, responsive to receiving the sensor data from motion detection logic 130, content presentation logic 120 selects a reduced view 2006 of the 3D earth provided by content source 110 for presentation to the user via display screen 150.

Thus, using the application illustrated in FIGS. 19 and 20, a user can easily zoom in on a 3D object and zoom out from the 3D object simply by moving electronic device 100 toward or away from his/her body. Other motions may be associated with zooming in on or zooming out from the 3D object. For example, in contrast to the application shown in FIGS. 19 and 20, moving electronic device 100 away from the user may be associated with zooming out from the 3D object and moving electronic device 100 toward the user may be associated with zooming in on the 3D object. This is only one example, and many other motions may be used to achieve the intended effect.

### D. Example Processor-Based Implementation

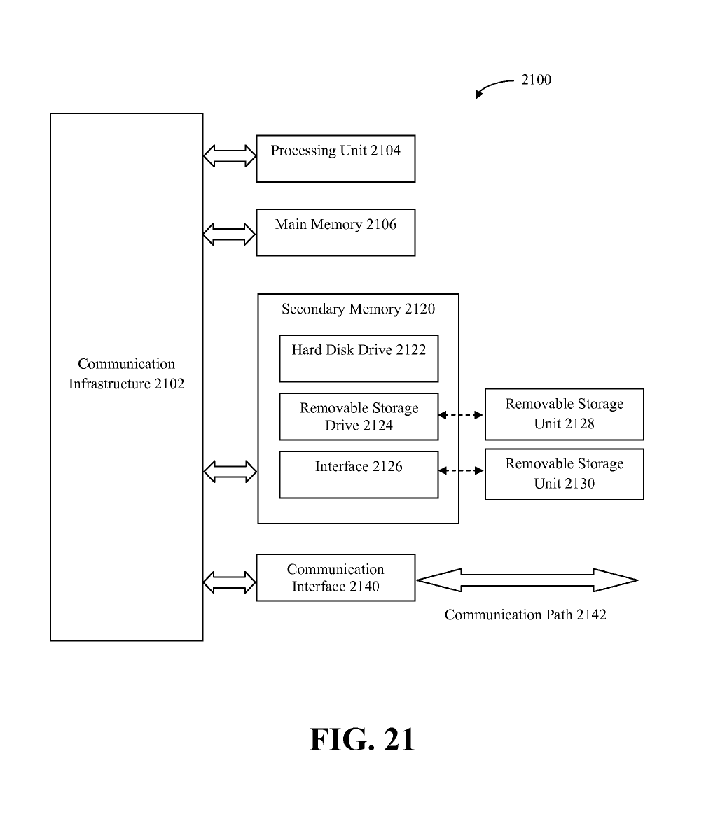

Certain elements of electronic device 100 shown in FIG. 1 as well as certain steps of flowcharts 600, 1100 and 1500 depicted in FIGS. 6, 11 and 15 may be implemented by one or more processor-based devices or systems. An example of such a system 2100 is depicted in FIG. 21.

As shown in FIG. 21, system 2100 includes a processing unit 2104 that includes one or more processors. Processor unit 2104 is connected to a communication infrastructure 2102, which may comprise, for example, a bus or a network.

System 2100 also includes a main memory 2106, preferably random access memory (RAM), and may also include a secondary memory 2120. Secondary memory 2120 may include, for example, a hard disk drive 2122, a removable storage drive 2124, and/or a memory stick. Removable storage drive 2124 may comprise a floppy disk drive, a magnetic tape drive, an optical disk drive, a flash memory, or the like. Removable storage drive 2124 reads from and/or writes to a removable storage unit 2128 in a well-known manner. Removable storage unit 2128 may comprise a floppy disk, magnetic tape, optical disk, or the like, which is read by and written to by removable storage drive 2124. As will be appreciated by persons skilled in the relevant art(s), removable storage unit 2128 includes a computer usable storage medium having stored therein computer software and/or data.

In alternative implementations, secondary memory 2120 may include other similar means for allowing computer programs or other instructions to be loaded into system 2100. Such means may include, for example, a removable storage unit 2130 and an interface 2126. Examples of such means may include a program cartridge and cartridge interface (such as that found in video game devices), a removable memory chip (such as an EPROM, or PROM) and associated socket, and other removable storage units 2130 and interfaces 2126 which allow software and data to be transferred from removable storage unit 2130 to system 2100.

System 2100 may also include a communication interface 2140.

Communication interface 2140 allows software and data to be transferred between system 2100 and external devices. Examples of communication interface 2140 may include a modem, a network interface (such as an Ethernet card), a communications port, a PCMCIA slot and card, or the like. Software and data transferred via communication interface 2140 are in the form of signals which may be electronic, electromagnetic, optical, or other signals capable of being received by communication interface 2140. These signals are provided to communication interface 2140 via a communication path 2142. Communications path 2142 carries signals and may be implemented using wire or cable, fiber optics, a phone line, a cellular phone link, an RF link and other communications channels.

As used herein, the terms “computer program medium” and “computer readable medium” are used to generally refer to media such as removable storage unit 2128, removable storage unit 2130 and a hard disk installed in hard disk drive 2122.

Computer program medium and computer readable medium can also refer to memories, such as main memory 2106 and secondary memory 2120, which can be semiconductor devices (e.g., DRAMs, etc.). These computer program products are means for providing software to system 2100.

Computer programs (also called computer control logic, programming logic, or logic) are stored in main memory 2106 and/or secondary memory 2120. Computer programs may also be received via communication interface 2140. Such computer programs, when executed, enable system 2100 to implement features of the present invention as discussed herein. Accordingly, such computer programs represent controllers of the computer system 2100. Where an aspect of the invention is implemented using software, the software may be stored in a computer program product and loaded into system 2100 using removable storage drive 2124, interface 2126, or communication interface 2140.

The invention is also directed to computer program products comprising software stored on any computer readable medium. Such software, when executed in one or more data processing devices, causes a data processing device(s) to operate as described herein. Embodiments of the present invention employ any computer readable medium, known now or in the future. Examples of computer readable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

### E. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for presenting content to a display screen of an electronic device, comprising:
sensing motion of the electronic device;
generating sensor data responsive to the sensed motion;
modifying an orientation of at least a portion of the content to be presented to the display screen based on the sensor data; and
presenting the content to the display screen.

2. The method of claim 1, wherein the content comprises one or more of text, an image, or a video.

3. The method of claim 1, wherein the content comprises an image and text, and wherein modifying the orientation of at least a portion of the content to be presented to the display screen comprises rotating the image but not rotating the text.

4. A method for presenting content to a display screen of an electronic device, comprising:
sensing motion of the electronic device;
generating sensor data responsive to the sensed motion;
selecting a portion of the content for presentation to the display screen based on the sensor data; and
presenting the selected portion of the content to the display screen.

5. The method of claim 4, wherein the content comprises one or more of text, an image, or a video.

6. The method of claim 4, wherein selecting the portion of the content for presentation to the display screen based on the sensed motion comprises:
determining that the sensor data is associated with a scrolling function; and
selecting the portion of the content based on scrolling the content upward or downward within the display screen responsive to determining that the sensor data is associated with the scrolling function.

7. A method for presenting a view of a three-dimensional (3D) object to a display screen of an electronic device comprising:
sensing motion of the electronic device;
generating sensor data responsive to the sensed motion;
selecting one of a plurality of views of the 3D object based on the sensor data; and
presenting the selected view of the 3D object to the display screen.

8. An electronic device, comprising:
a display screen;
motion detection logic configured to sense motion of the electronic device and to generate sensor data responsive to the sensed motion;
a content source configured to provide content for presentation to the display screen;
content presentation logic configured to modify an orientation of at least a portion of the content to be presented to the display screen based on the sensor data; and
a display interface configured to present the content to the display screen.

9. The electronic device of claim 8, wherein the motion detection logic comprises an accelerometer.

10. The electronic device of claim 8, wherein the motion detection logic comprises a compass sensor.

11. The electronic device of claim 8, wherein the motion detection logic comprises an orientation sensor.

12. The electronic device of claim 8, wherein the content comprises one or more of text, an image, or a video.

13. The electronic device of claim 8, wherein the content comprises an image and text, and wherein the content presentation logic is configured to rotate the image but not rotate the text.

14. An electronic device, comprising:
a display screen;
motion detection logic configured to sense motion of the electronic device and to generate sensor data responsive to the sensed motion;
a content source configured to provide content for presentation to the display screen;
content presentation logic configured to select a portion of the content for presentation to the display screen based on the sensor data; and
a display interface configured to present the selected portion of the content to the display screen.

15. The electronic device of claim 14, wherein the motion detection logic comprises an accelerometer.

16. The electronic device of claim 14, wherein the motion detection logic comprises a compass sensor.

17. The electronic device of claim 14, wherein the motion detection logic comprises an orientation sensor.

18. The electronic device of claim 14, wherein the content comprises one or more of text, an image, or a video.

19. The electronic device of claim 14, wherein the content presentation logic is configured to determine that the sensor data is associated with a scrolling function and to select the portion of the content based on scrolling the content upward or downward within the display screen responsive to determining that the sensor data is associated with the scrolling function.

20. An electronic device, comprising:
a display screen;
motion detection logic configured to sense motion of the electronic device and to generate sensor data responsive to the sensed motion;
a content source configured to provide multiple views of a three-dimensional (3D) object;
content presentation logic configured to select one of the multiple views of the 3D object based on the sensor data; and
a display interface configured to present the selected view of the 3D object to the display screen.

21. The electronic device of claim 20, wherein the motion detection logic comprises an accelerometer.

22. The electronic device of claim 20, wherein the motion detection logic comprises a compass sensor.

23. The electronic device of claim 20, wherein the motion detection logic comprises an orientation sensor.
